(19) United States
(12) Patent Application Publication
(10) Pub. No.: US 2026/0307567 A1
(43) Pub. Date: Oct. 8, 2026

(54) Headrest for a Vehicle Seat with a Sensor System for Head Padding Position Detection

(71) Applicant: Illinois Tool Works Inc., Glenview, IL (US)

(72) Inventor: Jordi Bielsa Bonet, Barcelona (ES)

(21) Appl. No.: 19/638,397

(22) Filed: Apr. 3, 2026

(30) Foreign Application Priority Data
Apr. 4, 2025 (DE) 10 2025 113 283.6

(51) Int. Cl. B60N 2/879; B60N 2/806

(52) U.S. Cl. CPC B60N 2/879; B60N 2/806

(57) ABSTRACT

A headrest for a vehicle seat includes adjustable rods guided in a headrest guide assembly. A sensor system integrated in the guide assembly detects the vertical position of the headrest rods and generates a corresponding electronic signal. An evaluation device processes the signal and compares the detected position with an optimal target position derived from an individual user profile, which is created from an interior camera detecting occupant stature or from manual input. If a safety-relevant deviation between the actual and target positions is detected, the system issues an optical and/or acoustic alert to prompt correction. The system further detects complete removal of the headrest and provides a corresponding critical alert to enhance occupant safety.

### RELATED APPLICATION

The present application claims the benefit of German Patent Application No. DE 10 2025 113 283.6, filed Apr. 4, 2025, titled “Headrest for a Vehicle Seat with a Sensor System for Head Padding Position Detection,” the contents of which are hereby incorporated by reference.

### BACKGROUND

Headrests are an essential part of the passive safety system in vehicles. Its primary function is to reduce the effect of forces on the cervical spine when vehicle movement changes suddenly, such as in particular those that occur in a rear-end collision. A correctly positioned headrest provides support for the head and neck and prevents excessive backward movement (hyperextension), dramatically reducing the risk of serious injuries such as neck strain (whiplash), fractures or long-term spinal damage. In addition to this safety aspect, headrests are also used to increase ride comfort.

To accommodate these functions, headrests are typically adjustable to allow for individual adjustment to different occupants of the vehicle. Typically, headrests are at least height-adjustable and can be mechanically locked at different positions. To this end, the headrests typically have headrest rods with locking points and a cushioned bearing structure (head cushion). The headrest rods are held and guided in respective receptacles in the seat back of the vehicle seat.

A major drawback of this known prior art is that the correct adjustment of the headrest is entirely dependent on the attention and knowledge of the user. Experience shows that adjustment of the headrests is often neglected or performed incorrectly in practice. In some cases, the headrests are set so low that they cannot provide protection in the event of an accident. Without or with a poorly adjusted headrest, the head lacks the necessary support during the critical backward movement after an impact. Even at low speeds, there is a risk of significant injuries to the neck region.

For optimum protection, the upper edge of the headrest should be positioned at or slightly above the top of the occupant's head, and the distance between the back of the head and the headrest should be minimal. Thus, in the case of a vehicle or driver change, in addition to the adjustment of the seat and the mirrors, the correct adjustment of the headrest is also essential. This is a manual action that is error-prone and does not provide the vehicle with a means to check or provide feedback.

### SUMMARY OF THE DISCLOSURE

The present disclosure relates generally to adjustable headrest assemblies, substantially as illustrated by and described in connection with at least one of the figures, as set forth more completely in the claims.

### BRIEF DESCRIPTION OF THE DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIGS. 1a and 1b illustrate schematic representations of a first embodiment with discrete position detection using a plurality of reading components.

FIGS. 2a through 2c illustrate schematic representations of a second embodiment with continuous position detection using an optical sensor.

FIGS. 3a through 3c illustrate schematic representations of a third embodiment for sensing two positions by means of a closed/open circuit.

FIGS. 4a through 4c illustrate schematic representations of a fourth embodiment for sensing multiple positions by means of separate circuits.

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples, and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y.” As another example, “x, y, and/or z” means any element of the seven-element set {(x), (y), (z), (x, y), (x, z), (y, z), (x, y, z)}. In other words, “x, y, and/or z” means “one or more of x, y, and z.”

The present disclosure relates to adjustable headrest assemblies for vehicle seats, in particular for motor vehicle seats. The disclosure relates in particular to a headrest for a vehicle seat having a sensor system for sensing the headrest position, as well as a system for monitoring this position.

The object of the present disclosure is therefore to specify a headrest assembly and an associated monitoring system for a vehicle that overcomes the drawbacks of the prior art. In particular, a solution is to be created that enables a safe, simple, and quick check of the headrest position in order to ensure an optimal position for the vehicle occupant that is correct in terms of safety, and to actively alert the user in the event of incorrect positioning.

This sensor system is arranged in the headrest guide assembly and is configured to sense the position of the headrest rods relative to the guide assembly. The core of the disclosure is that the headrest itself has the ability to “know” its own position and provide this information in the form of an electronic signal. This transforms the previously passive mechanical headrest into an active, intelligent component of the vehicle safety system.

The decisive advantage of this solution is the creation of a database for active safety monitoring. Rather than relying on a manual check by the user, the headrest according to the disclosure provides an objective, machine-readable signal. This signal may be processed by the vehicle electronic system to determine whether a safety-relevant condition, namely the correct headrest height, is met. This reduces dependence on the human factor and thus proactively increases occupant safety, as the system can detect and respond to incorrect positioning even before an accident occurs.

Another significant advantage is the intelligent and cost-efficient integration of the sensor system.

By placing the sensor system in the headrest guide assembly, a component that is typically installed in the seat back and is often made of plastic, a robust and durable solution can be realized. The sensor system is protected from mechanical stress and damage, unlike if it were attached directly to the movable head cushion, for example. In addition, this placement allows a simple electrical connection to the vehicle's electrical system and opens the possibility of integrating the sensor system directly and cost-efficiently into the guide part by means of modern manufacturing methods, such as the in-mold method.

The disclosure provides various alternative implementations of the sensor system in order to ensure wide applicability and flexibility.

For example, position detection may be performed by inductive, capacitive, or Hall effect sensors that respond to corresponding markings on the headrest rods. Alternatively, an optical distance sensor may provide continuous and highly precise measurement of the position.

A further conceivable variant is implementation via electrical contacts, which close one or more circuits depending on the position of the headrest rod and thus allow discrete position detection. This diversity ensures that a suitable technical solution can be found for every application and cost target.

This system is based on the headrest according to the disclosure and expands it with an intelligence layer. In addition to the headrest with a sensor system, it comprises a device for capturing a user profile (e.g., body size, eye height) and an evaluation device.

The evaluation device is configured to match the actual position of the headrest detected by the sensor system with a target position that is derived from the user profile. The system thus creates a link between the mechanical adjustment and the individual biometric data of the occupant.

An advantage of this system lies in the implementation of a personalized and adaptive safety function. Instead of a generalized check, the system allows for a safety assessment tailored to each occupant. It detects whether the current headrest height is actually correct and safe for the specific person, whether tall or short. This significantly increases the effectiveness of the protection provided by the headrest, as the optimal position depends on the stature of the occupant. For example, after a driver change, the system may automatically check the headrest position and adjust it to the profile of the new driver or issue a warning.

Moreover, the system significantly improves comfort and usability. It relieves the user of the need to manually check and determine the correct setting.

By means of an optical or acoustic alert, for example, an illuminated symbol in the dashboard or an audible cue, the user is proactively and intuitively made aware of a potentially dangerous incorrect position. This feedback can be designed individually by the vehicle manufacturer and fits seamlessly into the existing human-machine interface (HMI) of the vehicle.

The user profile can be detected in a variety of ways, giving the system a high level of flexibility. In an advanced embodiment, an interior camera may automatically and in real time sense the size and seating position of the occupant.

Alternatively or additionally, seat occupancy sensors may provide data. In a simpler variant, the user may manually enter their height via a user interface, for example a touchscreen, whereupon the system calculates and checks the ideal headrest position. This scalability allows the technology to be deployed in different vehicle classes.

This system uses the headrest according to the disclosure and an evaluation device to issue an alert when the sensor system senses that one or both headrest rods are no longer received by the guide assembly, i.e., the headrest has been removed.

The prominent benefit of this design is the creation of a fail-safe mechanism for a basic safety requirement. A dismounted headrest does not provide any protection in the event of an accident. Such a state may occur unnoticed, for example after the headrest has been removed for cleaning or for folding down the rear seat and has not been reinserted correctly. The system reliably detects this highly critical state and unambiguously alerts the driver, thereby closing a significant safety gap.

The technical implementation of this monitoring is particularly robust and simple. The system can be configured to issue a warning when no signal is received at all from the sensor system. For example, if a sensor that responds to markings on the rod no longer detects any marking, or if a system with electrical contacts reports a permanently open circuit, the evaluation device can logically deduce that the headrest is missing. This represents reliable and inherently secure monitoring logic.

Integration of this function into the overall system is seamless. The same sensor system used for positioning can also be used for presence detection.

No additional sensor is required, making the solution cost-efficient and easy to implement. The alert can be issued via the same channels as the position alert and clearly signal to the driver that a basic component of the safety system is missing.

According to a preferred embodiment, it may be provided that the headrest guide assembly is associated with an evaluation device, or that the headrest guide assembly has an evaluation device configured to determine, on the basis of the position of the headrest rods and/or headrest rod portions detected by the at least one sensor system of the headrest guide assembly, a corresponding position of a head cushion arranged on the headrest rods and/or headrest rod portions.

This allows conversion of the raw sensor signal into specific, usable position information, such as “position 3 of 5” or an absolute height indication. This processing creates the basis for comparison with an optimal target position. The evaluation device can also include the logic for controlling alerts and serve as a central interface to the remaining vehicle electronics.

According to implementations of the disclosure, it is provided that the headrest guide assembly has at least one sensor system configured to sense whether the headrest rods are received by the headrest guide assembly.

This configuration allows the basic safety check of whether the headrest is mounted in the seat. The system can detect a critical incorrect condition, such as driving without a headrest, and alert the driver. This presence detection is a robust basic function that significantly increases occupant safety.

In an alternative further development, it may be provided that the headrest guide assembly has at least one sensor system configured to at least indirectly sense a distance and/or a position of a head cushion arranged on the headrest rods relative to the seat back of the vehicle seat.

This indirect detection via the distance of the head cushion to the seat back provides an alternative method of height determination. It makes it possible to directly determine the position of the safety-relevant cushion rather than only measuring the position of the rods. This may further improve the accuracy of the safety assessment.

According to a preferred embodiment, it may be provided that the sensor system has at least one distance sensor configured to at least indirectly sense a length of a region of a headrest rod received by the headrest guide assembly.

The height of the headrest can be precisely determined by detecting the insertion depth of the rod into the seat back. This method is robust and insensitive to external influences and provides a reliable basis for calculating the head cushion position.

In an alternative further development, it may be provided that the headrest rod has a plurality of markings or markers distributed along its length, and the distance sensor detects one of these markings.

This enables a simple and cost-effective implementation of discrete position detection. The markings may be magnetic, optical, or material in nature and provide clear, defined switch points for the sensor. This principle is technically well developed, fail-safe, and easy to implement.

According to implementations of the disclosure, it is provided that the markings are formed as separate reading components attached to or integrated into the headrest rod, with each reading component allowing unique position detection through the sensor system.

This provides high flexibility in manufacturing, as the headrest rod and reading components can be made from different materials. For example, a steel rod may be combined with magnetic or plastic-encased reading components to optimize detection. In addition, this approach facilitates a modular design and simplifies assembly.

According to a preferred embodiment, it may be provided that the at least one distance sensor is embodied as an inductive distance sensor, a capacitive distance sensor, or a Hall effect sensor.

These non-contact sensor principles are particularly durable and wear-free because no mechanical friction occurs. They are insensitive to dust and moisture within the seat structure. Their proven technology ensures high reliability over the entire service life of the vehicle.

In an alternative further development, it may be provided that the headrest guide assembly is at least partially embodied as an injection-molded plastic part, and the distance sensor is integrated into the injection-molded plastic part via an in-mold method.

This manufacturing process allows for highly integrated and cost-efficient production. The sensor is directly enclosed during the injection molding process, which positions it precisely and protects it from environmental factors. This reduces the number of assembly parts and steps and increases the quality and repeatability of the final product.

According to implementations of the disclosure, it is provided that the sensor system has at least one optically operating distance sensor. An optical sensor can allow for very precise and continuous distance measurement, as opposed to discrete switch points.

This allows finer resolution of position detection and thus more accurate determination of the optimal headrest height. In addition, an optical sensor may also sense surface characteristics of the rod, which opens up additional detection possibilities.

According to a preferred embodiment, it may be provided that the optical distance sensor is configured to emit a signal and receive a signal reflected from the surface of the headrest rod to determine the distance to the headrest rod.

This time-of-flight, or reflection, principle is a proven method for non-contact distance measurement. It is robust to different light conditions within the seat structure and allows direct measurement of the rod position without the need for special markings.

In an alternative further development, it may be provided that the headrest has a manually actuatable lock that blocks or releases the adjustability of the headrest rods.

The combination of electronic position detection with a conventional mechanical lock ensures that the headrest is securely fixed in place after adjustment. The user retains the usual haptic feedback when adjusting, while the electronic system supplements the mechanical function with intelligent monitoring without altering the basic operation.

According to a preferred embodiment, it may be provided that the headrest guide assembly has first and second guide sleeve bodies for the two headrest rods.

The use of two separate guide sleeves ensures stable and precise guidance of the headrest rods. This prevents tilting or clamping during height adjustment. In addition, it offers the option of integrating the sensor system into only one of the two sleeves, thereby saving costs, while the other sleeve performs purely mechanical guiding tasks.

In an alternative further development, it may be provided that the guide sleeve bodies are received in corresponding receptacles in the seat back of the vehicle seat.

This modular design significantly simplifies assembly of the seat. The guide sleeves may be inserted into the seat structure as pre-assembled units, which also facilitates maintenance or replacement of the components.

According to implementations of the disclosure, it is provided that the sensor system is at least partially integrated into the first and/or second guide sleeve bodies.

The direct integration of the sensor system into the guide sleeves is an elegant solution in terms of manufacturing technology and functionality. It ensures a compact design and optimally protects the sensitive electronics. In addition, the distance between the sensor and the headrest rod is precisely defined and constant.

According to a preferred embodiment, it may be provided that the headrest rod has at least one conductive portion and the sensor system has electrical contacts that come into contact with the conductive portion to form a closed circuit.

This principle allows for very simple, robust, and cost-efficient position detection. It does not require complex sensor electronics but is based on a simple switch principle. Reliability is very high because a closed circuit is a clear and easily evaluated signal.

In an alternative further development, it may be provided that the headrest rod has a plurality of separate conductive portions and/or the headrest guide assembly has a plurality of sets of electrical contacts.

By arranging multiple conductive portions and/or contact pairs at different heights, multiple discrete positions of the headrest can be detected. This allows incremental height detection using simple means. The system can thus distinguish not only presence but also specific, predefined height positions.

According to implementations of the disclosure, it is provided that the system issues an alert via a corresponding optical and/or acoustic interface if the determined position does not match the user profile.

The active warning to the user is a key aspect of increasing safety. A visual warning in the instrument cluster or an acoustic message ensures that the driver perceives the information and is prompted to correct the adjustment. This completes the control loop from detection and assessment to the recommended action.

According to a preferred embodiment, it may be provided that the device for capturing a profile has a sensor system, in particular a camera, or a user interface for inputting body height.

The use of a camera allows for fully automatic and dynamic detection of the occupant height without any interaction from the user. This provides a high level of comfort and ensures that verification is always based on current data, even with changing occupants. Manual input via a user interface is a more cost-effective, yet still very effective, alternative that enables a personalized safety check.

In an alternative further development, it may be provided that the system further has a seat sensor for detecting the presence of a user, and the evaluation device uses the data captured by the seat sensor.

By including a seat sensor, the system can detect whether the seat is occupied at all. The check and any warning are thus activated only when relevant, which avoids unnecessary messages. Furthermore, advanced seat sensors (e.g., a pressure mat) may provide information about the height or weight of the occupant that further refines the user profile.

In summary, the disclosure represents a major further development in the field of passive vehicle safety by addressing one of the most common causes of serious neck injuries in accidents: an incorrectly adjusted headrest. Instead of relying on the knowledge and care of the driver, the headrest itself becomes an intelligent component that knows and reports its own position. This closes a critical gap in the safety concept of modern vehicles, as incorrect positions that drastically increase the risk of whiplash can now be automatically detected.

At the heart of the disclosure is the integration of an intelligent sensor system directly into the headrest guide assembly, which is typically located in the seat back. These sensors are positioned to precisely sense the vertical position of the headrest rods.

This approach has the decisive advantage that the sensitive electronics are protected and are wear-free inside the seat. Thus, the headrest becomes an active, data-supplying safety element rather than a purely passive mechanical component, providing an objective basis for an automated check.

An intelligent monitoring system is built on this hardware foundation. An evaluation device in the vehicle, for example the central control unit, receives the position data of the headrest.

The main advantage of this system is that it matches this actual position with an ideal target position that is safe for the occupant. If the system detects a safety-relevant deviation, the driver is proactively informed by an optical or acoustic alert in the cockpit. This creates a closed control loop ranging from detection and assessment to the recommended action to the user, thereby actively managing the level of safety.

A particular advantage of the system is its ability to personalize, allowing for a tailored safety assessment for the particular occupant.

The determination of the optimal target position may be made in a variety of ways. In a highly integrated variant, an interior camera automatically captures the body and head size of the occupant. Alternatively, the user can enter their data in a personal driver profile or manually via a user interface. By combining this with seat occupancy sensors, the system also ensures that a check only takes place when the seat is actually occupied.

To technically implement the position detection, the disclosure provides a variety of robust and flexible solutions, ensuring broad applicability. Contactless detection can be performed via inductive, capacitive, or Hall effect sensors, which react to special markings on the rods.

Alternatively, an optical sensor allows for highly precise, continuous distance measurement.

Another particularly robust variant utilizes electrical contacts that form closed circuits via conductive portions on the rods and thus report defined positions.

This technological diversity allows adaptation to different requirements and vehicle classes and enables cost-efficient integration of the sensor system, for example directly during the injection molding process of the guide parts (in-mold methods).

Beyond pure position monitoring, the disclosure addresses another critical safety problem: complete removal of the headrest. The system is capable of reliably detecting the absence of either or both headrest rods, such as when the sensor signal is completely absent. In this case, an unambiguous warning is issued to alert the driver of this extreme safety hazard.

Thus, the disclosure closes a significant and often overlooked safety gap and ensures that the passive restraint system can function as intended.

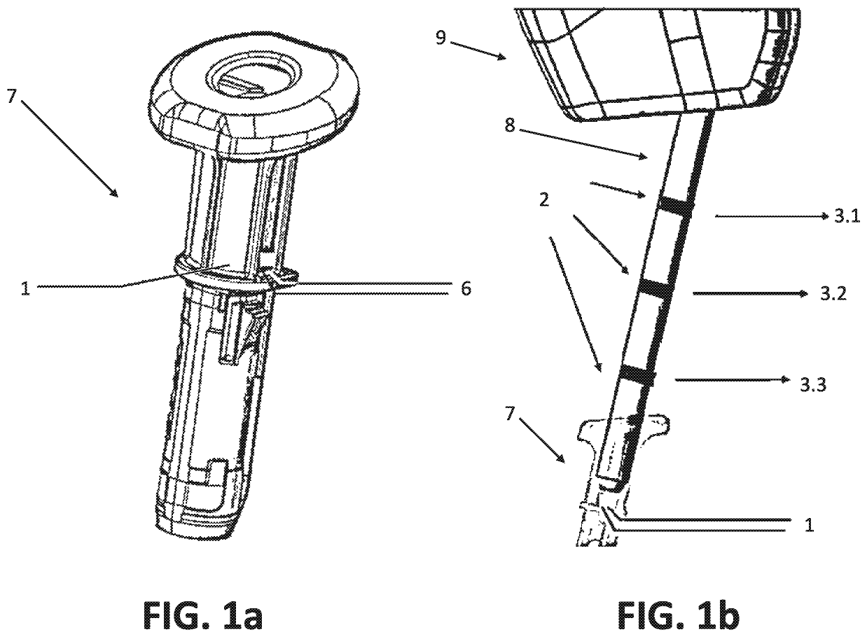

FIGS. 1a and 1b are schematic representations of a first embodiment with discrete position detection using a plurality of reading components (2).

This embodiment implements stepwise detection of the position of the headrest (9). In the headrest guide assembly (7), arranged in the seat back of a vehicle seat, a sensor system (1) is located at a defined installation point. This sensor system (1) (or sensor) may be embodied, for example, as an inductive proximity sensor, a capacitive proximity sensor, or a Hall effect sensor. The headrest rod (8), which is vertically displaceable in the headrest guide assembly (7), is provided with a plurality of spaced-apart reading components (2). In the illustrated embodiment, three such reading components (2) are provided, each corresponding to a particular height of the headrest (9).

When the headrest (9) is adjusted in height, the headrest rod (8) moves relative to the sensor system (1). Depending on which of the reading components (2) is in close proximity to the sensor system (1), the sensor system (1) detects that specific component and generates a corresponding signal. For example, the lowest reading component generates a lower position signal (3.3), the middle reading component generates a middle position signal (3.2), and the top reading component generates a high position signal (3.1).

These signals are forwarded to an evaluation device of the vehicle (e.g., an on-board computer system), which can derive the exact, discrete position of the headrest (9). This principle allows for very robust and reliable detection of predefined height levels.

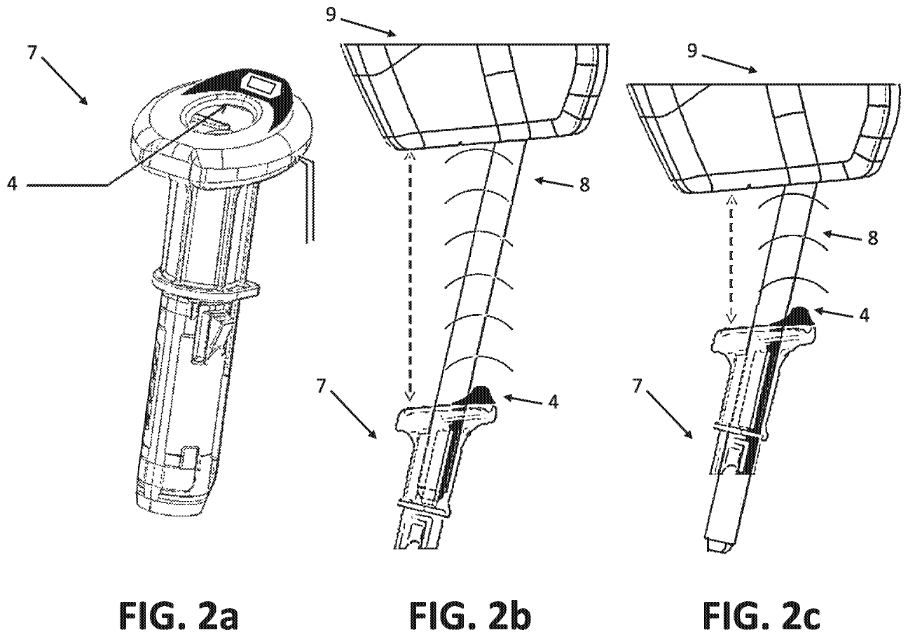

FIGS. 2a through 2c illustrate schematic representations of a second embodiment with continuous position detection using an optical sensor (4).

Unlike the discrete detection in FIGS. 1a and 1b, this embodiment allows for continuous and highly precise measurement of the position of the headrest (9). An optically operating distance sensor (4) is integrated in the headrest guide assembly (7). This sensor (4) may be embodied, for example, as an optical sensor or an analog range sensor. Integration of the sensor (4) can occur directly during manufacture of the guide sleeve of the headrest guide assembly (7), for example by casting (in-mold method), or in a downstream assembly step.

The sensor (4) emits a signal, for example a beam of light, toward the surface of the headrest rod (8) and/or the underside of the headrest (9). This signal is reflected by the headrest rod (8) and/or the underside of the headrest (9) and is received again by the sensor (4). Based on characteristics of the reflected signal, for example the time-of-flight or intensity, an evaluation device can calculate the exact distance between the sensor (4) and the headrest rod (8). As this distance changes continuously with height adjustment of the headrest (9), the sensor (4) provides an analog signal representing the exact height of the headrest (9).

This allows for very accurate determination of the position and precise adjustment to a target position that is optimal for the occupant.

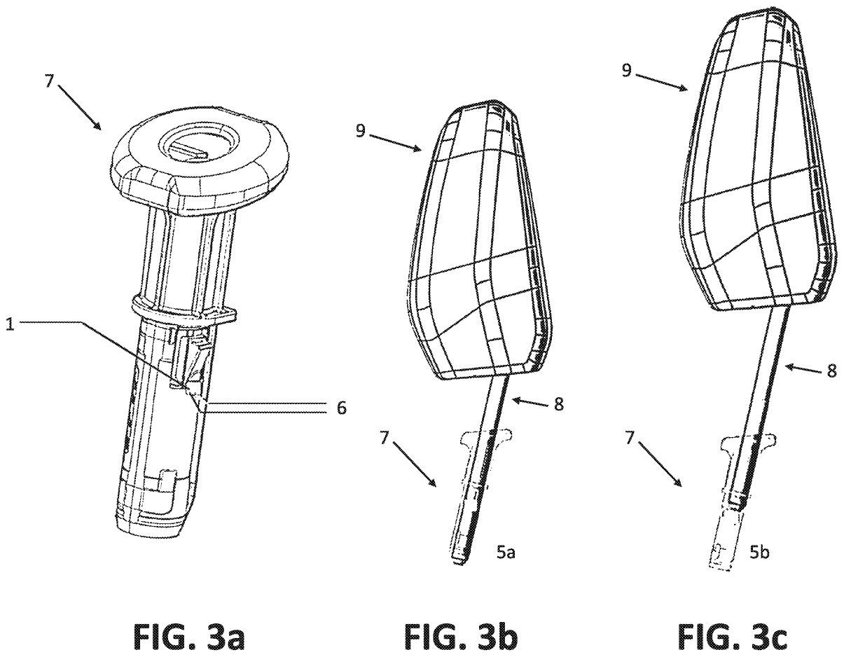

FIGS. 3a through 3c illustrate schematic representations of a third embodiment for sensing two positions by means of a closed/open circuit.

This embodiment utilizes a simple but highly robust switch principle. A sensor system (1) is integrated in the headrest guide assembly (7) at a specific location (6) and may be embodied as an inductive, capacitive, or Hall effect sensor. The headrest rod (8) has a particular feature in a corresponding region, for example a conductive portion or a magnet.

If this portion of the headrest rod (8) is at the height of the sensor system (1), a “closed circuit” condition (5a), or a detected state, is reported. If the headrest (9) is adjusted such that this portion is no longer within the sensing range of the sensor system (1), an “open circuit” condition (5b), or an undetected state, is reported. In this way, the system can reliably distinguish between two defined positions of the headrest (9). If the headrest rod (8) is not detected, the signal may also indicate that the headrest (9) has been removed, which is a critical condition.

A substantial additional advantage of this embodiment is presence detection. If the sensor system (1) does not detect a signal corresponding to a closed circuit over the entire adjustment range of the headrest (9), the evaluation device can conclude that the headrest (9) has been completely removed. This represents a critical safety state and can be reported to the driver immediately, as the protective function is no longer provided. The sensor system (1) may be positioned in a specific area, for example at the location (6), to detect defined headrest positions.

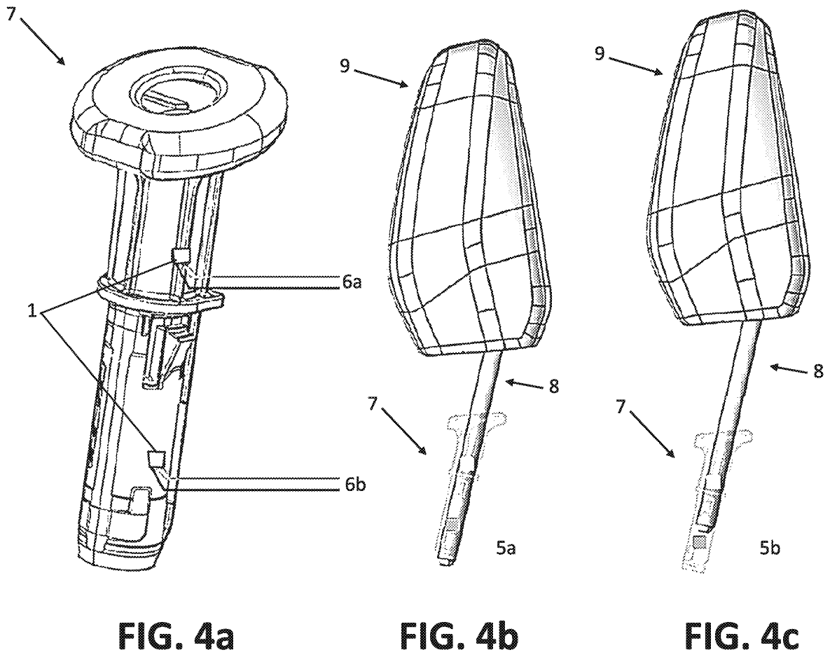

FIGS. 4a through 4c illustrate schematic representations of a fourth embodiment for detecting multiple positions using separate circuits.

This embodiment is a further development of the principle shown in FIGS. 3a through 3c and aims for higher accuracy and resolution in position detection. Here, at least two sensor systems (1) are arranged in the headrest guide assembly (7) at separate locations (6a, 6b) that are vertically spaced apart. Correspondingly, the headrest rod (8) has a plurality of detectable portions associated with the sensor systems (1).

Each sensor system (1) operates according to the open or closed circuit principle. The vehicle evaluation device simultaneously detects the states of all sensor systems (1). By logical combination of the individual sensor signals, a greater number of discrete positions can be distinguished. For example, the combination of “lower sensor closed, upper sensor open” may indicate a first position, while “lower sensor closed, upper sensor closed” indicates a second, higher position.

This allows for more precise, multi-stage detection of the headrest (9) height while maintaining the robustness of the simple switch principle. In this embodiment as well, the ability to detect a removed headrest (9) is fully retained.

While the present method and/or system has been described with reference to certain implementations, it will be understood by those skilled in the art that various changes may be made, and equivalents may be substituted without departing from the scope of the present method and/or system. In addition, many modifications may be made to adapt a particular situation or material to the teachings of the present disclosure without departing from its scope. For example, block and/or components of examples disclosed may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

What is claimed is:

1. A headrest for a vehicle seat, wherein the headrest comprises the following:
two headrest rods or headrest rod portions that extend at least substantially parallel and on which a head cushion of the headrest is or can be arranged; and
a headrest guide assembly via which the headrest rods and/or headrest rod portions are or can be received at least partially in a seat back of the vehicle seat in such a way that the headrest rods and/or headrest rod portions with the head cushion of the headrest arranged on the headrest rods and/or headrest rod portions can be adjusted in a longitudinal direction of extension of the headrest rods and/or headrest rod portions in relation to the headrest guide assembly between a first position and at least one second position,
wherein at least one sensor system is associated with the headrest guide assembly, or that the headrest guide assembly has at least one sensor system configured to detect at least one position of the headrest rods and/or the headrest rod portions relative to the headrest guide assembly.

2. The headrest according to claim 1,
wherein the headrest guide assembly is associated with an evaluation device or wherein the headrest guide assembly has an evaluation device configured to use the position of the headrest rods and/or the headrest rod portions detected by the at least one sensor system of the headrest guide assembly to determine a corresponding position of a head cushion arranged on the headrest rods and/or headrest rod portions.

3. The headrest according to claim 1,
wherein at least one sensor system is associated with the headrest guide assembly, or that the headrest guide assembly has at least one sensor system configured to detect whether the headrest rods and/or the headrest rod portions are received in the headrest guide assembly.

4. The headrest according to claim 1,
wherein at least one sensor system is associated with the headrest guide assembly or that the headrest guide assembly has at least one sensor system that is configured to determine at least indirectly a distance and/or a position of a head cushion arranged on the headrest rods and/or headrest rod portions from the seat back of the vehicle seat.

5. The headrest according to claim 1,
wherein the sensor system has at least one distance sensor configured to at least indirectly detect a length of a region of a headrest rod and/or a headrest rod portion accommodated by the headrest guide assembly or the seat back of the vehicle seat.

6. The headrest according to claim 5,
wherein the headrest rod and/or the headrest rod portion has a plurality of markings or markers distributed over the length of the headrest rod and/or the headrest rod portion, and wherein the at least one distance sensor is arranged in or on the headrest guide assembly and is configured to detect one of the markings or one of the markers of the headrest rod and/or the headrest rod portion that is located in close proximity to the distance sensor, and, on the basis of the detected marking or the detected marker, to infer a length of the region of the headrest rod and/or the headrest rod portion accommodated by the headrest guide assembly or the seat back of the vehicle seat.

7. The headrest according to claim 6,
wherein the markings are formed as separate reading components attached to or integral with the headrest rod, wherein each reading component allows for unique position detection through the sensor system.

8. The headrest according to claim 5,
wherein the at least one distance sensor is embodied as an inductive distance sensor, a capacitive distance sensor or a Hall effect sensor.

9. The headrest according to claim 5,
wherein the headrest guide assembly is embodied at least partially or regionally as an injection-molded plastic part, and wherein the at least one distance sensor is integrated in the injection-molded plastic part via an in-mold method.

10. The headrest according to claim 1,
wherein the sensor system has at least one optically operating distance sensor, which is configured to determine a distance and/or a position of a head cushion arranged on the headrest rods and/or headrest rod portions from the headrest guide assembly.

11. The headrest according to claim 10,
wherein the optical distance sensor is configured to emit a signal and receive a signal reflected from the surface of the headrest rod to determine the distance to the headrest rod.

12. The headrest according to claim 1, wherein the headrest further comprises the following:
a lock, which can be transferred between a first state and a second state, wherein the first state of the lock corresponds to a locked state in which an adjustability of the headrest rods and/or headrest rod portions in relation to the headrest guide assembly is blocked, and wherein the second state of the lock corresponds to an unlocked state in which an adjustability of the headrest rods and/or headrest rod portions in relation to the headrest guide assembly is possible.

13. The headrest according to claim 1,
wherein the headrest guide assembly has a first guide sleeve body, which is associated with a first headrest rod and/or a first headrest rod portion of the two headrest rods and/or two headrest rod portions and in which the first headrest rod and/or the first headrest rod portion is or can be at least partially or regionally received; and
wherein the headrest guide assembly has a second guide sleeve body, which is associated with a second headrest rod and/or second headrest rod portion of the two headrest rods and/or two headrest rod portions and in which the second headrest rod and/or second headrest rod portion is or can be at least partially or regionally received.

14. The headrest according to claim 13,
wherein the first guide sleeve body is received or receivable at least partially or regionally in a first receptacle embodied in or at the seat back of the vehicle seat, and wherein the second guide sleeve body is received or receivable at least partially or regionally in a second receptacle embodied in or at the seat back of the vehicle seat.

15. The headrest according to claim 13,
wherein the sensor system is at least partially or regionally integrated in the first and/or second guide sleeve body.

16. The headrest according to claim 1,
wherein the headrest rod has at least one conductive portion and the sensor system in the headrest guide assembly has electrical contacts arranged to come into contact with the conductive portion to form a closed circuit when the headrest rod is in a predetermined position.

17. The headrest according to claim 16,
wherein the headrest rod has a plurality of separate conductive portions and/or the headrest guide assembly has a plurality of sets of electrical contacts spaced apart longitudinally of the headrest rod to detect a plurality of different positions of the headrest rod.

18. A system for monitoring an adjusted position of a headrest of a vehicle seat, wherein the system comprises:
a headrest according to claim 1;
a device for detecting a profile of a user of the vehicle seat, wherein the profile relates to a body height of the user and/or an eye height of the user and/or a shoulder height of the user; and
an evaluation device, which is configured to determine, on the basis of the position of the head cushion arranged on the headrest rods and/or headrest rod portions detected or at least indirectly determined by the at least one sensor system of the headrest guide assembly, whether the determined position of the head cushion arranged on the headrest rods and/or headrest rod portions matches the user's body height stored in the user profile and/or the user's eye height stored in the user profile and/or the user's shoulder height stored in the user profile.

19. The system according to claim 18,
wherein the system is configured to issue an alert via a corresponding optical and/or acoustic interface if it is determined by the evaluation device that the determined position of the head cushion arranged on the headrest rods and/or headrest rod portions does not match the user's body height stored in the user profile and/or the user's eye height stored in the user profile and/or the user's shoulder height stored in the user profile.

20. The system according to claim 18,
wherein the device for detecting a profile of a user of the vehicle seat has a sensor system for detecting the user's body height, eye height and/or shoulder height; and/or
wherein the device for detecting a profile of a user of the vehicle seat has a user interface via which the body height, eye height and/or shoulder height of the user can be entered.
